(19) United States
(12) Patent Application Publication
(10) Pub. No.: US 2021/0241251 A1
(43) Pub. Date: Aug. 5, 2021

(54) SYSTEM AND METHOD FOR SMALL BUSINESS SERVICE AGGREGATION AND ABSTRACTION OF ECONOMIES OF SCALE

(71) Applicant: RockSpoon, Inc., San Jose, CA (US)

(72) Inventor: Nagib Georges Mimassi, Palo Alto, CA (US)

(21) Appl. No.: 17/037,256

(22) Filed: Sep. 29, 2020

Related U.S. Application Data
(60) Provisional application No. 62/969,851, filed on Feb. 4, 2020.

(51) Int. Cl. G06Q 20/20; G06Q 10/08; G06Q 10/10; G06Q 40/00; G06Q 20/14; G06Q 40/02; G06F 16/955

(52) U.S. Cl. CPC G06Q 20/202; G06Q 10/087; G06Q 10/1091; G06F 16/955; G06Q 40/125; G06Q 20/14; G06Q 40/02; G06Q 10/105

(57) ABSTRACT

A system and methods for small business service aggregation and abstraction of economies of scale, comprising a specialized software application operating on a server and communicating with customer devices, business-side devices, delivery service infrastructure, financial system infrastructure, and point-of-sale software, to provide for unified logistical and financial support for small businesses that do not have access to economy-of-scale effects on their logistical and administrative tasks.

### CROSS-REFERENCE TO RELATED APPLICATIONS

Application Date Filed Title
No.
Current Herewith A SYSTEM AND METHOD FOR SMALL
application BUSINESS SERVICE AGGREGATION AND
   ABSTRACTION OF ECONOMIES OF
   SCALE
   Claims benefit of, and priority to:
62/969,851 Feb. 4, 2020 SYSTEM AND METHOD FOR SMALL
   BUSINESS SERVICE AGGREGATION AND
   ABSTRACTION OF ECONOMIES OF
   SCALE
the entire specification of each of which is incorporated herein by reference.

### BACKGROUND OF THE INVENTION

### Field of the Art

The disclosure relates to the field of cloud technology, more specifically to the field of cloud applications integrating third-party services for retail merchants.

### Discussion of the State of the Art

An economy of scale is a useful concept in business, and reflects an all-too-true reality, in which a large-scale manufacturer or seller of some sort may experience lower cost-per-item than a smaller business, because of the advantages of having large infrastructure and being able to produce, sell, or otherwise market large quantities of items at a time, driving the cost-per-item down for large merchants, such as AMAZON™, WALMART™, or APPLE™. Any single person or local business has trouble competing with these companies at their own game, whether it is selling a variety of goods in a brick-and-mortar store, selling books specifically, or making and selling phones (which is almost entirely impossible for a small-scale operation to even achieve to begin with). But there are further benefits besides manufacture and sale of goods, for economies of scale, that aid large businesses but do not aid smaller ones.

Delivery infrastructure and centralization of logistics and finance are some of the biggest economy-of-scale boons for large, national or multinational corporations, to the point where some companies even have their own delivery services exclusively. A local store does not have these benefits typically, and might have to self-manage their deliveries if any through a normal postal system at greater inconvenience to themselves and their customer, and sometimes greater cost. The finances, bill payments, payroll, and more, are also often not easily centralized or automated for many smaller businesses.

What is needed is a system and method for logistical and financial integration and abstraction for small businesses, to provide an economy-of-scale effect for them through the use of cloud technology, to compete with larger businesses who can and often have set up their own systems for these purposes on their own.

### SUMMARY OF THE INVENTION

Accordingly, the inventor has conceived and reduced to practice, in a preferred embodiment of the invention, a system and methods for small business service aggregation and abstraction of economies of scale. The following non-limiting summary of the invention is provided for clarity, and should be construed consistently with embodiments described in the detailed description below.

A system has been devised for small business service aggregation and abstraction of economies of scale, comprising: a web application comprising at least a processor, a memory, a first plurality of programming instructions stored in the memory and operating on the processor, a user interface, a networking interface, a payment system interface, an inventory management engine, a scheduling engine, and a datastore, wherein the programming instructions, when operating on the processor, cause the processor to: facilitate communications with a network and the other components of the web application; allow a user to register with the application over a network; interface with online and cloud-based point of sale systems; interface and integrate with online goods delivery systems and services; interface and integrate with a business' inventory for inventory management purposes; facilitate managing of, planning for, and calculation of business payrolls; and allow business users to register and interface with the web application over a network.

A method has been devised for small business service aggregation and abstraction of economies of scale, comprising the steps of: facilitating communications with a network and the other components of the web application, using a web application; allowing a user to register with the application over a network, using a web application; interfacing with online and cloud-based point of sale systems, using a web application; interfacing and integrating with online goods delivery systems and services, using a web application; interfacing and integrating with a business' inventory for inventory management purposes, using a web application; facilitating management of, planning for, and calculation of business payrolls, using a web application; and allowing business users to register and interface with the web application over a network, using a web application.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram of an exemplary system for small business service aggregation and abstraction of economies of scale, according to an aspect.

FIG. 2 is a diagram of an exemplary application used in a system for small business service aggregation and abstraction of economies of scale, according to an aspect.

FIG. 3 is a method diagram of an exemplary system for small business service aggregation and abstraction of economies of scale, according to a preferred embodiment of the invention.

FIG. 4 is a message flow diagram of an exemplary system for small business service aggregation and abstraction of economies of scale, according to a preferred embodiment.

FIG. 5 is a method diagram of an exemplary application used in a system for small business service aggregation and abstraction of economies of scale, according to an aspect.

FIG. 6 is a method diagram of an exemplary system for small business service aggregation and abstraction of economies of scale, used for managing restaurant finances, deliveries, and integration with existing restaurant POS systems, according to an embodiment.

FIG. 7 is a message flow diagram of an exemplary system for small business service aggregation and abstraction of economies of scale, used for managing restaurant finances, deliveries, and integration with existing restaurant POS systems, according to an embodiment.

FIG. 8 is a method diagram of an exemplary system for small business service aggregation and abstraction of economies of scale, used for managing local pharmacy finances, deliveries, and integration with existing POS systems, and recording of sent copies of doctor information and prescriptions, according to an embodiment.

FIG. 9 is a message flow diagram of an exemplary system for small business service aggregation and abstraction of economies of scale, used for managing local pharmacy finances, deliveries, and integration with existing POS systems, and recording of sent copies of doctor information and prescriptions, according to an embodiment.

FIG. 10 is a method diagram of an exemplary system for small business service aggregation and abstraction of economies of scale, used for businesses inside of airports for the purposes of managing deliveries of goods to the store or restaurant, integration with existing POS systems, payroll management, and storing any relevant records, according to an embodiment.

FIG. 11 is a message flow diagram of an exemplary system for small business service aggregation and abstraction of economies of scale, used for businesses inside of airports for the purposes of managing deliveries of goods to the store or restaurant, integration with existing POS systems, payroll management, and storing any relevant records, according to an embodiment.

FIG. 12 is a block diagram illustrating an exemplary hardware architecture of a computing device.

FIG. 13 is a block diagram illustrating an exemplary logical architecture for a client device.

FIG. 14 is a block diagram showing an exemplary architectural arrangement of clients, servers, and external services.

FIG. 15 is another block diagram illustrating an exemplary hardware architecture of a computing device.

### DETAILED DESCRIPTION

The inventor has conceived, and reduced to practice, a system and method for . . . .

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

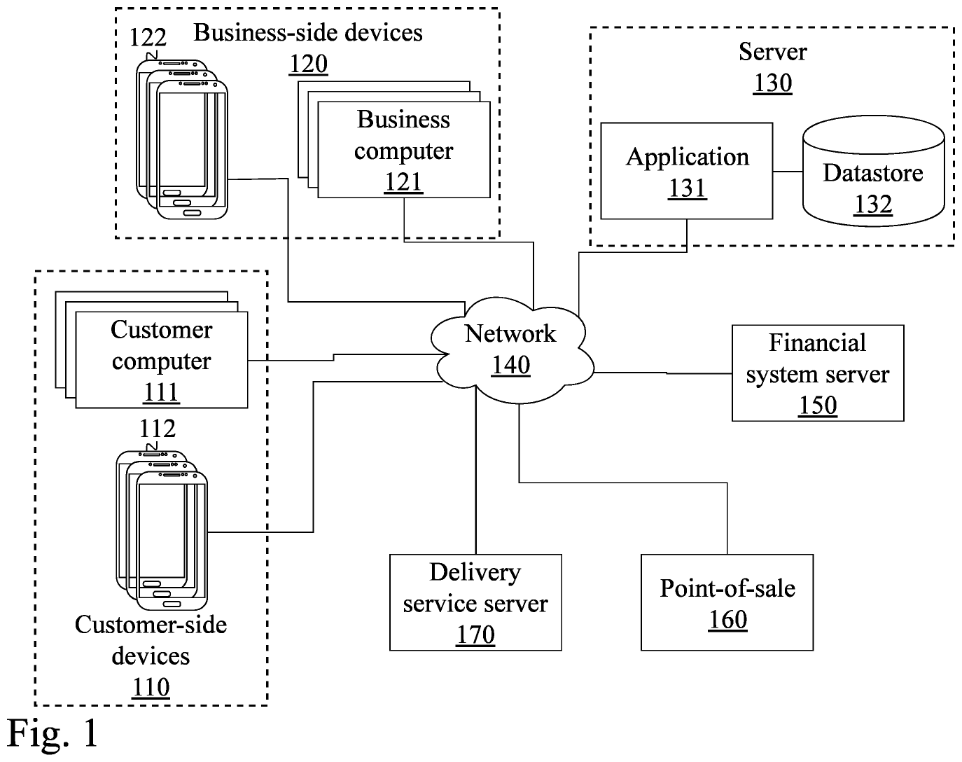

FIG. 1 is a diagram of an exemplary system for small business service aggregation and abstraction of economies of scale, according to an aspect. A possible plurality of customer-side devices 110 exists, which may be a customer computer or computers 111, or a customer mobile device or devices such as tablets or phones 112, or some combination thereof, capable of accessing networks including the internet 140. As well, at least one business-side device exists 120, such as a computer or computers 121 or a mobile device or devices such as tablets, or phones 122, similarly able to connect to networks including the internet 140. Such devices on both the customer and business side may have an operating system installed, such as WINDOWS™, MAC OS™, ANDROID™, LINUX™, or others, and possess at least a processor, a storage medium such as a hard drive or solid-state drive of some manner, network interface which may be wireless or wired, and volatile memory such as Random Access Memory (RAM). They may have these in any number of configurations that are possible for currently-available, historical, or future designs of computers and mobile computing devices. Also connected to the network 140, such as the internet, is a server 130, a computer device designed to server network resources such as web pages over Hypertext Transfer Protocol (“HTTP”), an application programming interface, or other data and functionality accessed over a network. This server possesses at least a software application 131 and datastore 132 which provide the key functionality that differentiate it from other servers that exist on the internet, the specific functionality of the application 131 and manner of data stored 132 and connections it receives over a network 140. Such an application 131 may be programmed in one of numerous programming languages such as C, C#, C++, JAVA™, or others, and a datastore 132 may be a database including SQL or NoSQL databases, or other data storage formats. Accessible over the same network 140 are a server operating for a financial system 150 such as a server for PAYPAL™ or some other financial institution which may be interfaced with, a point-of-sale (“POS”) 160 operating as part of a retail business or restaurant, and a server providing functionality and integration for a delivery service 170 such as GRUBHUB™ or UBER EATS™. These servers and the POS 150, 160, 170 must be able to operate software, and communicate over the network 140, therefore being constructed with at least a network interface, a processor unit, an operating system of some manner, volatile memory, and a storage medium such as a hard drive or solid-state drive.

As will be explained in further diagrams, the POS 150, delivery server 170, and financial server 160 may all be accessed and integrated from the server operating the application 130, 131, upon queries from either business devices 120 or customer devices 110, to integrate a small business with an economy of scale from a single point of access in the application, for the purposes of managing matters such as payroll, bill payments, inventory records, and managing deliveries to and from the business, without requiring the infrastructure for such services to be operated by or owned by the small business directly.

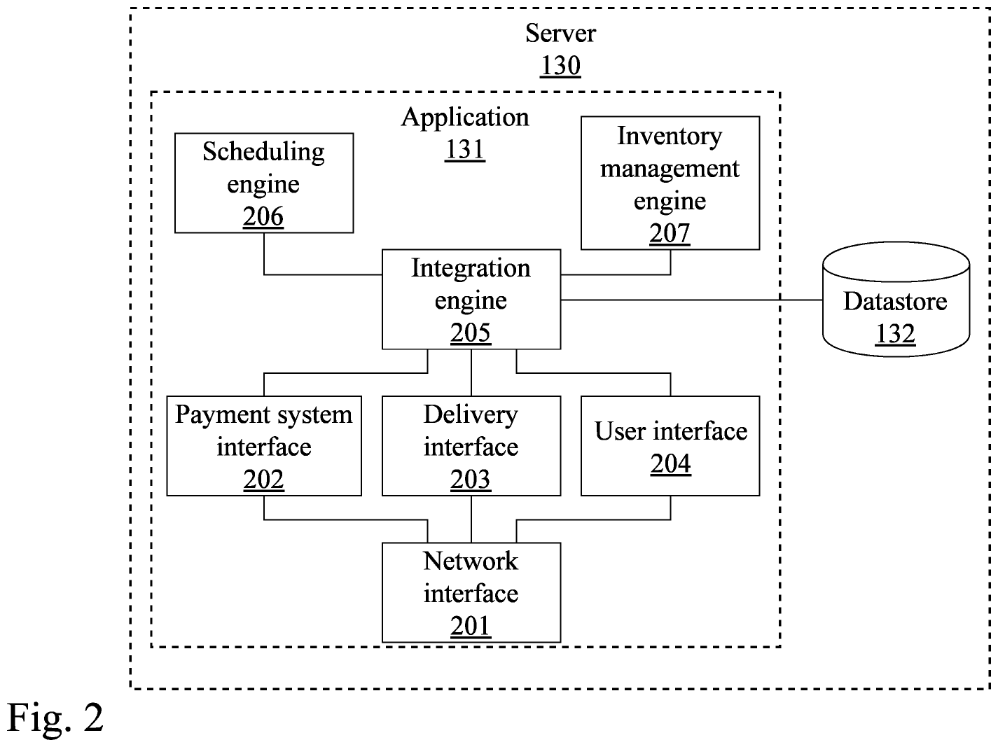

FIG. 2 is a diagram of an exemplary application used in a system for small business service aggregation and abstraction of economies of scale, according to an aspect. A server 130 exists which is a computer device designed to server network resources such as web pages over

Hypertext Transfer Protocol (“HTTP”), an application programming interface, or other data and functionality accessed over a network. This server possesses at least a software application 131 and datastore 132 which provide the key functionality that differentiate it from other servers that exist on the internet, the specific functionality of the application 131 and manner of data stored 132 and connections it receives over a network 140, with a network interface 201, which may be either wired or wireless, or both, as some servers and computers support multiple network interfaces and connections. Such an application 131 may be programmed in one of numerous programming languages such as C, C#, C++, JAVA™, or others, and a datastore 132 may be a database including SQL or NoSQL databases, or other data storage formats. An application 131 is a piece of software that, according to an embodiment, provides several software interfaces and engines in its functionality, including a payment system interface 202, a delivery interface 203, a user interface 204, an integration engine 205, a scheduling engine 206, and an inventory management engine 207.

The payment system interface 202 and delivery interface 203 are non-graphical interfaces capable of communicating with various servers and services over a network, such as with API calls or socket communications sessions or through the use of other protocols and techniques for network communications, with servers for delivery services such as GRUBHUB™ or financial institutions such as PAYPAL™ or even banks and credit unions for handling deposits and withdrawals. Interfaces may communicate with the web servers for the services specified by a user of the application 131, with specific communication protocols and parsing of exchanged messages designed for commonly used services, or communication protocols and services set up by the third party service providers for this purpose.

A user interface 204 is a graphical user interface providing accessibility to users, in this case business owners setting up integration with third party services and with the services of the application itself, accessed over a network such as the internet, and with which a user may specify settings including their username and password or other verification criteria such as biometrics, their preferred delivery service, their business location, their items that may be ordered from a delivery service and their prices and descriptions, billing information, payroll information including employees and their wages or salaries, financial institution integration such as PAYPAL™, integration with the business POS or website such that users may access the POS or website online and their order for delivery may be forwarded to the delivery service without the user ever leaving the business-specific services, and notification settings for the user of the account. Inventory management settings and scheduling settings for deliveries or inventory replenishments may also be set up by a user in the user interface 204.

An inventory management engine 207 and scheduling engine 206 are components of a software application 131, and are not directly accessible to a user interface 204, but are used as part of the back-end of the application to manage portions of the data and function of the application 131. An inventory management engine 207 may be used to evaluate input records of inventory stores from a user with a user interface 204, and, when records of inventory are input, may deduct the appropriate amount from the inventory records when an order is placed with the system, as received by the delivery interface 203. A scheduling engine 206 may schedule deliveries, payments and payroll, and may be used in some cases for scheduling deliveries to the business from suppliers to replenish inventory. An integration engine 205 manages the communications between the different interfaces and engines of the application 131, and may do this by managing and wrapping objects in the application from an Object-Oriented Programming (“OOP”) perspective, by communicating with separate pieces of software in the application thus making it a suite of software running on the server rather than a single application, or by merely being an abstraction of a central thread or main program loop that operates and manages the other aspects of the code as differing aspects of the application—in other words treating the integration engine as the actual “application” and making the other interfaces and engines merely abstract concepts of different parts of the application. The integration engine 205, regardless of which approach is taken in the operation and development of the application 131, also handles communication with the datastore 132 to store relevant records, such as user data, settings, and data from the third party systems connected to the application such as a connection string to connect to a delivery service server for forwarding customer orders.

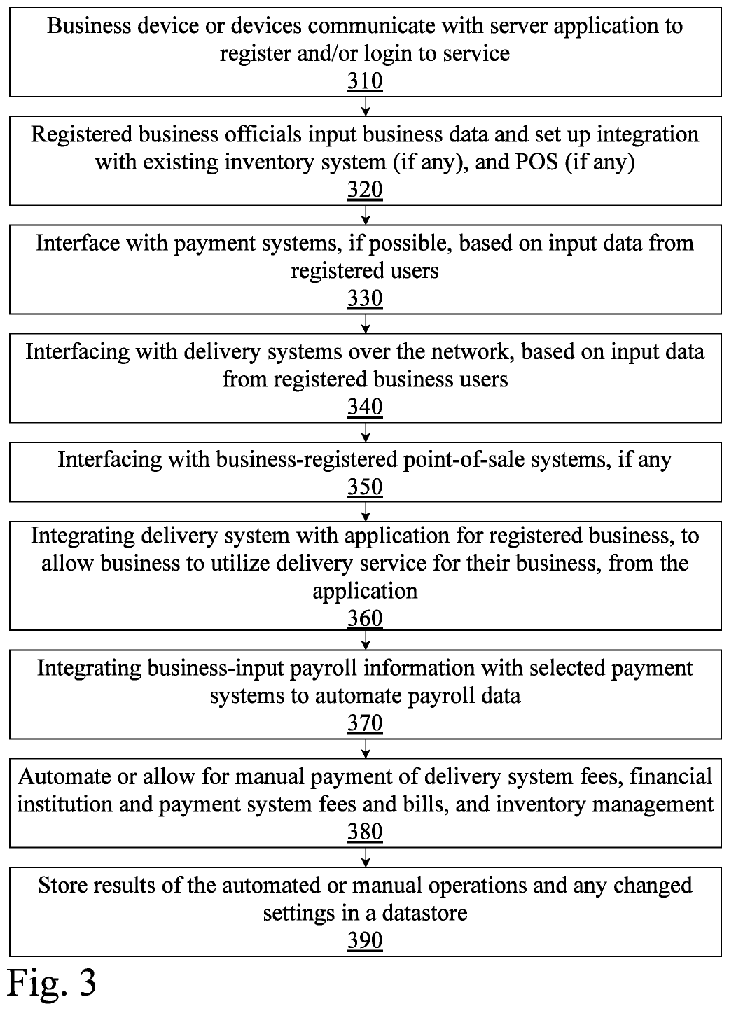

FIG. 3 is a method diagram of an exemplary system for small business service aggregation and abstraction of economies of scale, according to a preferred embodiment of the invention. First, a business device or devices communicate with a server application to register and/or login to service 310, which may occur using a website and web portal, a specialized application that communicates with the server application, or some other method of communicating with a server and application over a network such as the internet. Protocols for such communication include TCP/IP, HTTP, or UDP protocols. The registered business official or officials may then input business data and set up integration with existing inventory system (if any), and POS (if any) 320 into the application. This is done with a graphical user interface (“GUI”), and may include such data as personal information, business information including business name and location and tax number, menu of food items or other items for non-restaurant businesses, scheduling bill payments and specifying the amount to pay and whom to pay it to, and more. After settings are input for the specific services to integrate and automations to put in place, the application may interface with payment systems, if possible, based on input data from registered users 330, such as connecting to the user's PAYPAL™ or bank account for the purpose of auto-withdrawing funds for bill and payroll payments, or for the purpose of depositing funds into the account(s) when deliveries are ordered and approved. Similarly, the application may interface with delivery systems over a network, based on input data from registered business users 340, such as GRUBHUB™ or MR. DELIVERY™, through a non-graphical interface, to connect and send orders received on the software application to the delivery server if received and if the business official has set up their account in this way. The application may then interface with business-registered point-of-sale systems, if any 350, such as an online website the business operates, which may have a database connection string provided, where the sales software operated may create or edit entries in the database which are then detected by the application, to detect new sales and manage the stored inventory appropriately. The integration may also take the form of online order data such as items bought, purchase confirmation, amount paid, delivery location, and other relevant details as required, being forwarded to the application by the website or other online ordering platform the business may have, and being forwarded to the integrated delivery service such as UBER EATS™. Integrating the delivery system with the application for registered business, to allow business to utilize delivery service for their business, from the application 360, may also take a similar form to integrating for deliveries for customers, except that the customer may be the business itself, for the purpose of ordering supplies and goods from suppliers, on a regular schedule or manually, through the application, providing a single point for this service rather than requiring the business manager or owner to go to the supplier's website for the delivery to be set up. Integrating business-input payroll information with selected payment systems to automate payroll data 370 may also be done if the business owner or manager who is registered with the application inputs the payroll data and the proper credentials to pay the employees from their preferred financial institution, using for example STRIPE™ or PAYPAL™ payment services. With the payroll data input into the application, this may also be used to automate or allow for manual payment of delivery system fees, financial institution and payment system fees and bills, and inventory management 380 with inventory numbers and POS integration set up, with any orders, changes in inventory or settings, payroll and bill payments, or any other changes in any stored accounts or integrated services being stored in a datastore 390 for later viewing and recordkeeping purposes, which may be viewed from the graphical user interface.

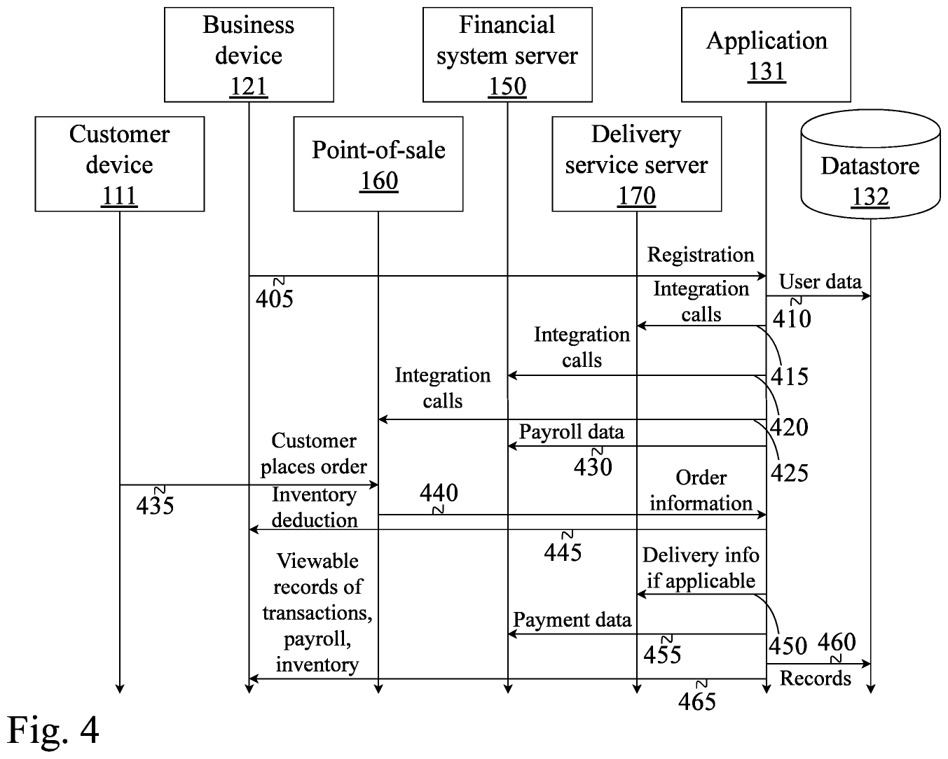

FIG. 4 is a message flow diagram of an exemplary system for small business service aggregation and abstraction of economies of scale, according to a preferred embodiment. The message flow diagram shows connectivity and exchanged messages, and is described herein with their effects in the system, between at least a customer device 111 which may be a personal computer, a mobile phone, a tablet, or other manner of computing device, a business device or devices 121 which may be a personal computer, a mobile phone, a tablet, or other manner of computing device, a point-of-sale or POS system 160 which may include a website or web-accessed application for customers to place delivery orders, a financial system server 150 such as a server accepting communications for services such as PAYPAL™ or VENMO™, a delivery service server 170 such as a server for accepting delivery orders operated by GRUBHUB™ or MR. DELIVERY™, the software application 131, and a datastore 132. First, a business device or devices communicate with a server application to register and/or login to service 405, which may occur using a website and web portal, a specialized application that communicates with the server application, or some other method of communicating with a server and application over a network such as the internet. Registration data such as the identity and verification methods and values for a newly registered user are stored in a datastore 410, 132. Protocols for such communication include TCP/IP, HTTP, or UDP protocols. Similarly, the application may interface and integrate with delivery systems over a network, based on input data from registered business users 415, such as GRUBHUB™ or MR. DELIVERY™, through a non-graphical interface, to connect and send orders received on the software application to the delivery server if received and if the business official has set up their account in this way. Integrating the delivery system with the application for registered business, to allow business to utilize delivery service for their business, from the application, may take a similar form to integrating for deliveries for customers, except that the customer may be the business itself, for the purpose of ordering supplies and goods from suppliers, on a regular schedule or manually, through the application, providing a single point for this service rather than requiring the business manager or owner to go to the supplier's website for the delivery to be set up. After settings are input for the specific services to integrate and automations to put in place, the application may interface with payment systems, if possible, based on input data from registered users 420, such as connecting to the user's PAYPAL™ or bank account for the purpose of auto-withdrawing funds for bill and payroll payments, or for the purpose of depositing funds into the account(s) when deliveries are ordered and approved. The registered business official or officials may then input business data and set up integration with existing inventory system (if any), and POS (if any) 425 into the application. This is done with a graphical user interface (“GUI”), and may include such data as personal information, business information including business name and location and tax number, menu of food items or other items for non-restaurant businesses, scheduling bill payments and specifying the amount to pay and whom to pay it to, and more. The application may then interface with business-registered point-of-sale systems, if any 425, such as an online website the business operates, which may have a database connection string provided, where the sales software operated may create or edit entries in the database which are then detected by the application, to detect new sales and manage the stored inventory appropriately. The integration may also take the form of online order data such as items bought, purchase confirmation, amount paid, delivery location, and other relevant details as required, being forwarded to the application by the website or other online ordering platform the business may have, and being forwarded to the integrated delivery service such as UBER EATS™. Integrating business-input payroll information with selected payment systems to automate payroll data 430 may also be done if the business owner or manager who is registered with the application inputs the payroll data and the proper credentials to pay the employees from their preferred financial institution, using for example STRIPE™ or PAYPAL™ payment services.

A customer then may place an order for delivery 435 from a mobile or computing device 111, which may be a mobile phone, tablet, laptop, desktop, personal digital assistant, or other computing device. The order may be placed with a specialized application that the business uses for online POS 160 or a website that is accessible with a web browser, using HTTP, HTTPS, TCP/IP, UDP, or other protocols common for internet communications, and using a possible variety of encryption protocols that are common for such internet communications. This order is forwarded from the POS 160 via a network connection, to the application 131, 440, using HTTP, HTTPS, TCP/IP, UDP, or other protocols common for internet communications, and using a possible variety of encryption protocols that are common for such internet communications. An inventory deduction message is sent to the POS 445, 160 if set up by the business in the software application 131, which may be, for instance, a JSON string containing the ID of the inventory item that is being deducted, the amount, and more, for the purposes of local recordkeeping. Delivery information is sent to the delivery service server 170, 450 from the application 131 similarly over a network using HTTP, HTTPS, TCP/IP, UDP, or other protocols common for internet communications, and using a possible variety of encryption protocols that are common for such internet communications, potentially in the form of a JSON, or in another form such as a custom API call to the delivery service, depending on the implementation of the delivery service server. With payroll data input into the application, if the payroll data was input by the business owner or manager during registration and setup 405, 410, this may also be used to automate or allow for manual payment of delivery system fees, financial institution and payment system fees and bills, and inventory management 455 with inventory numbers and POS integration set up, with any orders, changes in inventory or settings, payroll and bill payments, or any other changes in any stored accounts or integrated services being stored in a datastore 460 for later viewing and recordkeeping purposes, which may be viewed from the graphical user interface 465. Communications between servers and services in this diagram may take the form of specialized messages between the services, API calls, JSON strings sent to the servers of certain services, or other methods of communication between a web server and another device, many of which are known to the art.

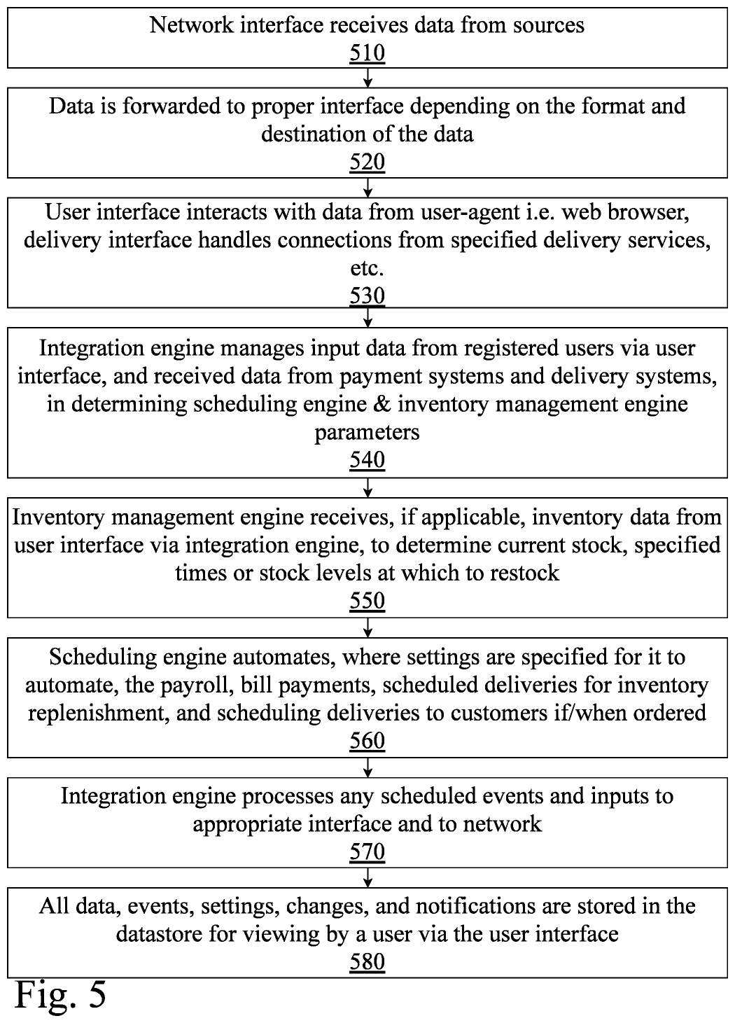

FIG. 5 is a method diagram of an exemplary application used in a system for small business service aggregation and abstraction of economies of scale, according to an aspect. A network interface receives data from devices and data sources on a connected network 510, including user devices (“users” in the context of this method being businesses registered or registering with the application), before data is parsed and forwarded to proper interface depending on the format and destination of the data 520, the data parsing consisting of analyzing it for identifiers of where it comes from and what the application is expecting to see, for instance, if the application is capable of integrating with three different institutions A, B, and C, A and B being financial institutions and institution C being a delivery service that the application is capable of interfacing with, and it expects to communicate via JSON strings sent between each other, and it receives a JSON string identifying itself as institution A, it will be forwarded to the payment system interface. JSON strings are not the only or requisite manner of communication between the application and other services, other methods such as POST-GET with data in other formats, or individual API calls for actions to be taken between the application and the third party service, may also be possible. A user interface interacts with data received from identified user-agent i.e. a web browser, while the delivery interface handles connections from specified delivery services, and the payment service interface handles and identifies data from financial institutions, 530 before an integration engine manages input data from registered users via user interface, and received data from payment systems and delivery systems, in determining scheduling engine & inventory management engine parameters 540. An inventory management engine may receive, if applicable, inventory data from user interface via integration engine, to determine current stock, specified times or stock levels at which to restock 550, while a scheduling engine automates, where settings are specified for it to automate, the payroll, bill payments, scheduled deliveries for inventory replenishment, and scheduling deliveries to customers if/when ordered 560. For instance, receiving data about a deposit from the business into their account that is connected to the application may result in the system being able to automatically schedule payroll payments if the account was previously short, and the integration engine may enable the scheduling engine to then make payments on-time automatically, if enabled by the business account to do so. Likewise, the integration engine may calculate based on current numbers stored in a datastore and any newly received data whether or not the business is in need of, and able to pay for, new inventory shipments, which may be enabled by the business account in their account settings, and make the necessary payments with the payment system interface, while ordering the goods for their inventory replenishment with the delivery system interface, allowing an integration engine to process any scheduled events and send appropriate data and outgoing requests to the appropriate interface, and then to the network interface and to the network at large 570. Any and all data, events, settings, changes, and notifications are stored in the datastore for viewing by a user via the user interface 580.

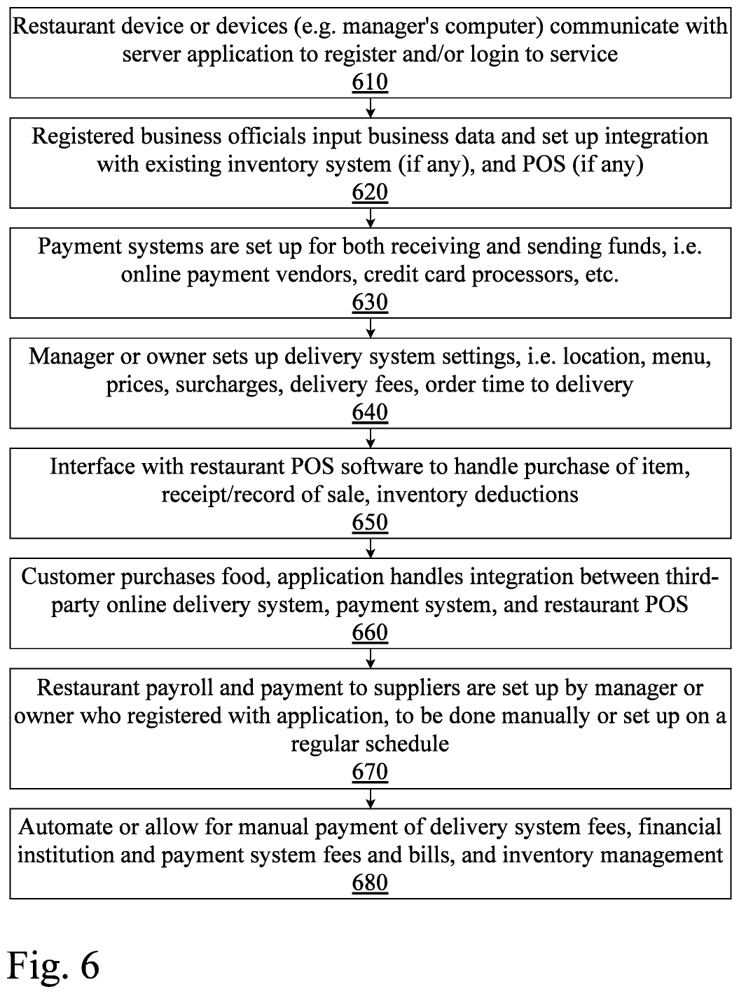

FIG. 6 is a method diagram of an exemplary system for small business service aggregation and abstraction of economies of scale, used for managing restaurant finances, deliveries, and integration with existing restaurant POS systems, according to an embodiment. First, a restaurant device or devices communicate with a server application to register and/or login to service 610, which may occur using a website and web portal, a specialized application that communicates with the server application, or some other method of communicating with a server and application over a network such as the internet. Protocols for such communication include TCP/IP, HTTP, or UDP protocols. A “restaurant device” may be such a device operated in the interest of the business by an owner or manager of the restaurant, such as a desktop on-site, or a business smartphone owned by the owner or manager, whoever may be authorized to sign up for business applications and services for the restaurant. The registered business official or officials may then input business data and set up integration with existing inventory system (if any), and POS (if any) 620 into the application. This is done with a graphical user interface (“GUI”), and may include such data as personal information, business information including business name and location and tax number, menu of food items or other items for non-restaurant businesses, scheduling bill payments and specifying the amount to pay and whom to pay it to, and more. Such an inventory for a restaurant may include things such as the amount of fresh lobster at a seafood restaurant, the number of onions in stock, or anything else they may wish to keep track of. After settings are input for the specific services to integrate and automations to put in place, the application may interface with payment systems, if possible, based on input data from registered users 630, such as connecting to the user's PAYPAL™ or bank account for the purpose of auto-withdrawing funds for bill and payroll payments, or for the purpose of depositing funds into the account(s) when deliveries are ordered and approved. Similarly, the application may interface with delivery systems over a network, based on input data from registered business users 640, such as GRUBHUB™ or MR. DELIVERY™, through a non-graphical interface, to connect and send orders received on the software application to the delivery server if received and if the business official has set up their account in this way. Delivery settings may include at least menu items and their prices and descriptions, and estimated time for certain items to be made. The application may then interface with the restaurant POS software to handle purchase of item, receipt/record of sale, inventory deductions 650, such as an online website the business operates, which may have a database connection string provided, where the sales software operated may create or edit entries in the database which are then detected by the application, to detect new sales and manage the stored inventory appropriately. The integration may also take the form of online order data such as items bought, purchase confirmation, amount paid, delivery location, and other relevant details as required, being forwarded to the application by the website or other online ordering platform the business may have, and being forwarded to the integrated delivery service such as UBER EATS™. A customer may then purchase food, application handles integration between third-party online delivery system, payment system, and restaurant POS 660, may also take a similar form to integrating for deliveries for customers, except that the customer may be the business itself, for the purpose of ordering supplies and goods from suppliers, on a regular schedule or manually, through the application, providing a single point for this service rather than requiring the business manager or owner to go to the supplier's website for the delivery to be set up. Integration of restaurant payroll and payment to suppliers may be set up by the manager or owner who registered with application, to be done manually or set up on a regular schedule 670, if the business owner or manager who is registered with the application inputs the payroll data and the proper credentials to pay the employees from their preferred financial institution, using for example STRIPE™ or PAYPAL™ payment services. With the payroll data input into the application, this may also be used to automate or allow for manual payment of delivery system fees, financial institution and payment system fees and bills, and inventory management 680 with inventory numbers and POS integration set up.

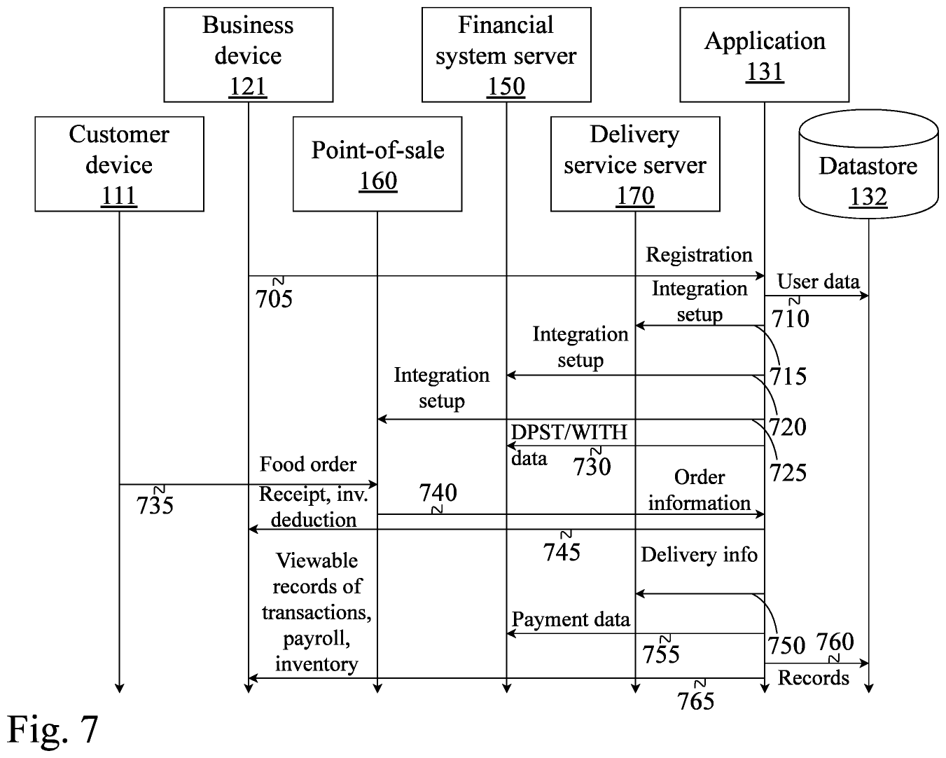

FIG. 7 is a message flow diagram of an exemplary system for small business service aggregation and abstraction of economies of scale, used for managing restaurant finances, deliveries, and integration with existing restaurant POS systems, according to an embodiment. The message flow diagram shows connectivity and exchanged messages, and is described herein with their effects in the system, between at least a customer device 111 which may be a personal computer, a mobile phone, a tablet, or other manner of computing device, a business device or devices 121 which may be a personal computer, a mobile phone, a tablet, or other manner of computing device, a point-of-sale or POS system 160 which may include a website or web-accessed application for customers to place delivery orders, a financial system server 150 such as a server accepting communications for services such as PAYPAL™ or VENMO™, a delivery service server 170 such as a server for accepting delivery orders operated by GRUBHUB™ or MR. DELIVERY™, the software application 131, and a datastore 132. First, a business device or devices communicate with a server application to register and/or login to service 705, which may occur using a website and web portal, a specialized application that communicates with the server application, or some other method of communicating with a server and application over a network such as the internet. Registration data such as the identity and verification methods and values for a newly registered user are stored in a datastore 710, 132. Protocols for such communication include TCP/IP, HTTP, or UDP protocols. Similarly, the application may interface and integrate with delivery systems over a network, based on input data from registered business users 715, such as GRUBHUB™ or MR. DELIVERY™, through a non-graphical interface, to connect and send orders received on the software application to the delivery server if received and if the business official has set up their account in this way. Integrating the delivery system with the application for registered business, to allow business to utilize delivery service for their business, from the application, may take a similar form to integrating for deliveries for customers, except that the customer may be the business itself, for the purpose of ordering supplies and goods from suppliers, on a regular schedule or manually, through the application, providing a single point for this service rather than requiring the business manager or owner to go to the supplier's website for the delivery to be set up. After settings are input for the specific services to integrate and automations to put in place, the application may interface with payment systems, if possible, based on input data from registered users 720, such as connecting to the user's PAYPAL™ or bank account for the purpose of auto-withdrawing funds for bill and payroll payments, or for the purpose of depositing funds into the account(s) when deliveries are ordered and approved. The registered business official or officials may then input business data and set up integration with existing inventory system (if any), and POS (if any) 725 into the application. This is done with a graphical user interface (“GUI”), and may include such data as personal information, business information including business name and location and tax number, menu of food items or other items for non-restaurant businesses, scheduling bill payments and specifying the amount to pay and whom to pay it to, and more. The application may then interface with business-registered point-of-sale systems, if any 725, such as an online website the business operates, which may have a database connection string provided, where the sales software operated may create or edit entries in the database which are then detected by the application, to detect new sales and manage the stored inventory appropriately. The integration may also take the form of online order data such as items bought, purchase confirmation, amount paid, delivery location, and other relevant details as required, being forwarded to the application by the website or other online ordering platform the business may have, and being forwarded to the integrated delivery service such as UBER EATS™. Integrating business-input payroll information with selected payment systems to automate payroll data 730 as well as automatic withdrawals for regular inventory purchases and deposits from the business, to pay off bills and credit on a specific schedule, effectively allowing the application to be a bill manager for a restaurant, which may also be done if the business owner or manager who is registered with the application inputs the payroll data and the proper credentials to pay the employees from their preferred financial institution, using for example STRIPE™ or PAYPAL™ payment services. A customer then may place an order for delivery 735 from a mobile or computing device 111, which may be a mobile phone, tablet, laptop, desktop, personal digital assistant, or other computing device. The order may be placed with a specialized application that the business uses for online POS 160 or a website that is accessible with a web browser, using HTTP, HTTPS, TCP/IP, UDP, or other protocols common for internet communications, and using a possible variety of encryption protocols that are common for such internet communications. This order is forwarded from the POS 160 via a network connection, to the application 131, 740, using HTTP, HTTPS, TCP/IP, UDP, or other protocols common for internet communications, and using a possible variety of encryption protocols that are common for such internet communications. An inventory deduction message is sent to the POS 745, 160 if set up by the business in the software application 131, which may be, for instance, a JSON string containing the ID of the inventory item that is being deducted, the amount, and more, for the purposes of local recordkeeping. Delivery information is sent to the delivery service server 170, 750 from the application 131 similarly over a network using HTTP, HTTPS, TCP/IP, UDP, or other protocols common for internet communications, and using a possible variety of encryption protocols that are common for such internet communications, potentially in the form of a JSON, or in another form such as a custom API call to the delivery service, depending on the implementation of the delivery service server. With payroll data input into the application, if the payroll data was input by the business owner or manager during registration and setup 705, 710, this may also be used to automate or allow for manual payment of delivery system fees, financial institution and payment system fees and bills, and inventory management 755 with inventory numbers and POS integration set up, with any orders, changes in inventory or settings, payroll and bill payments, or any other changes in any stored accounts or integrated services being stored in a datastore 760 for later viewing and recordkeeping purposes, which may be viewed from the graphical user interface 765. Communications between servers and services in this diagram may take the form of specialized messages between the services, API calls, JSON strings sent to the servers of certain services, or other methods of communication between a web server and another device, many of which are known to the art.

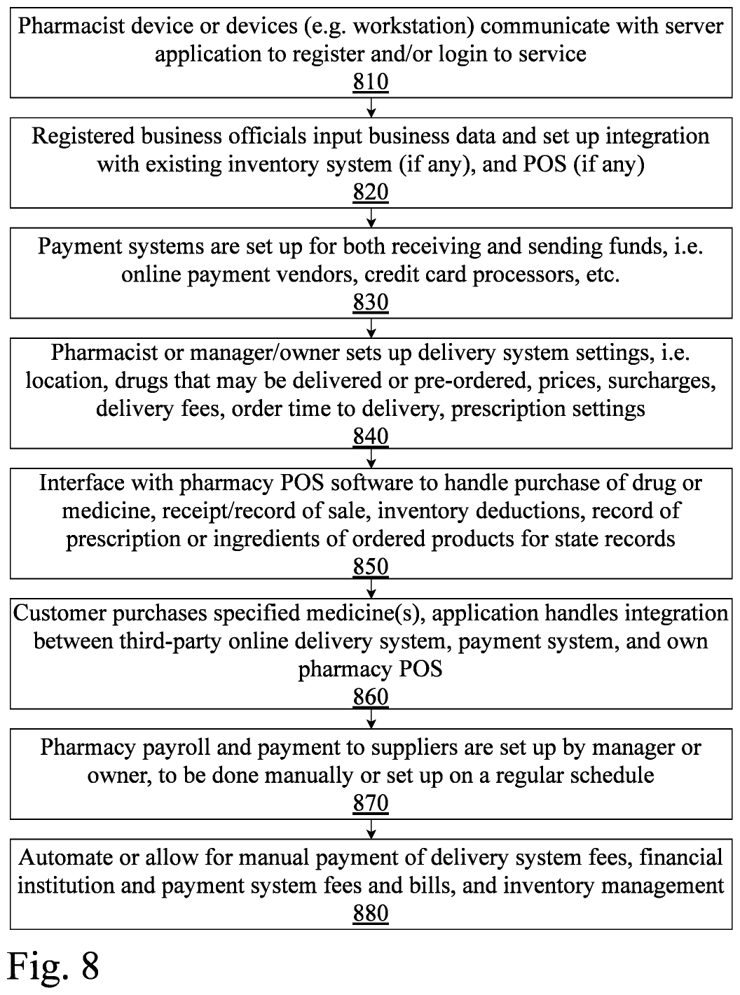

FIG. 8 is a method diagram of an exemplary system for small business service aggregation and abstraction of economies of scale, used for managing local pharmacy finances, deliveries, and integration with existing POS systems, and recording of sent copies of doctor information and prescriptions, according to an embodiment. First, a pharmacy business device or devices communicate with a server application to register and/or login to service 810, which may occur using a website and web portal, a specialized application that communicates with the server application, or some other method of communicating with a server and application over a network such as the internet. Protocols for such communication include TCP/IP, HTTP, or UDP protocols. This may be a device owned and located in the pharmacy itself, or owned and operated by the owner or manager authorized to make business decisions on the pharmacy's behalf, such as their work-phone or other device. The registered business official or officials may then input business data and set up integration with existing inventory system (if any), and POS (if any) 820 into the application. This is done with a graphical user interface (“GUI”), and may include such data as personal information, business information including business name and location and tax number, menu of food items or other items for non-restaurant businesses, scheduling bill payments and specifying the amount to pay and whom to pay it to, and more. After settings are input for the specific services to integrate and automations to put in place, the application may interface with payment systems, if possible, based on input data from registered users 830, such as connecting to the user's PAYPAL™ or bank account for the purpose of auto-withdrawing funds for bill and payroll payments, or for the purpose of depositing funds into the account(s) when deliveries are ordered and approved. A pharmacist or manager/owner of a pharmacy, depending on the arrangement of the business, may set up delivery system settings, such as the business location, drugs or other products that may be delivered or pre-ordered, prices, surcharges, delivery fees, order time to delivery, prescription requirements, and more 840, through a non-graphical interface, to connect and send orders received on the software application to the delivery server if received and if the business official has set up their account in this way. The application may then interface with pharmacy POS software to handle purchases of drug or medicine over a network such as for delivery, create a receipt/record of sale through the delivery system for the POS and for records with the application, manage inventory deductions, record of prescription or ingredients of ordered products for state records 850, handling deliveries and other purchases not in person such as an online website the business operates, which may have a database connection string provided, where the sales software operated may create or edit entries in the database which are then detected by the application, to detect new sales and manage the stored inventory appropriately. The integration may also take the form of online order data such as items bought, purchase confirmation, amount paid, delivery location, and other relevant details as required, being forwarded to the application by the website or other online ordering platform the business may have, and being forwarded to the integrated delivery service such as. A customer may purchase specified medicine(s) from the online POS, with the application handling integration between third-party online delivery system, payment system, and the pharmacy POS 860, which may also take a similar form to integrating for deliveries for customers, except that the customer in this case may also be the business itself, for the purpose of ordering supplies and goods from suppliers, on a regular schedule or manually, through the application, providing a single point for this service rather than requiring the business manager or owner to go to the supplier's website for the delivery to be set up. In other words, the application may be used by the business itself, to place orders with other supplier companies, and even automatically set them up to occur under certain inventory or scheduling conditions, in addition to the application integrating with delivery systems for delivering goods to non-business-related customers such as people having their medicine delivered to their home. Integrating business-input payroll information with selected payment systems to automate payroll data 870 may also be done if the business owner or manager who is registered with the application inputs the payroll data and the proper credentials to pay the employees from their preferred financial institution, using for example STRIPE™ or PAYPAL™ payment services. With the payroll data input into the application, this may also be used to automate or allow for manual payment of delivery system fees, financial institution and payment system fees and bills, and inventory management 880 with inventory numbers and POS integration set up.

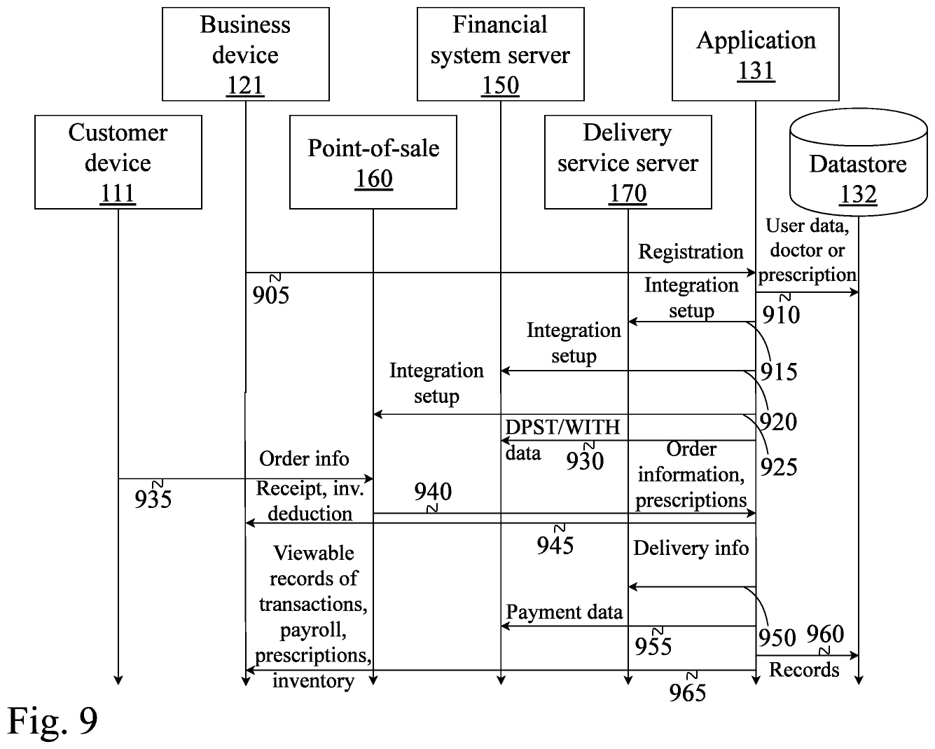

FIG. 9 is a message flow diagram of an exemplary system for small business service aggregation and abstraction of economies of scale, used for managing local pharmacy finances, deliveries, and integration with existing POS systems, and recording of sent copies of doctor information and prescriptions, according to an embodiment. The message flow diagram shows connectivity and exchanged messages, and is described herein with their effects in the system, between at least a customer device 111 which may be a personal computer, a mobile phone, a tablet, or other manner of computing device, a business device or devices 121 which may be a personal computer, a mobile phone, a tablet, or other manner of computing device, a point-of-sale or POS system 160 which may include a website or web-accessed application for customers to place delivery orders, a financial system server 150 such as a server accepting communications for services such as PAYPAL™ or VENMO™, a delivery service server 170 such as a server for accepting delivery orders operated by GRUBHUB™ or MR. DELIVERY™, the software application 131, and a datastore 132. First, a business device or devices communicate with a server application to register and/or login to service 905, which may occur using a website and web portal, a specialized application that communicates with the server application, or some other method of communicating with a server and application over a network such as the internet. Registration data such as the identity and verification methods and values for a newly registered user, as well as any doctor, healthcare provider, or prescription information that a customer shares are stored in a datastore 910, 132. Protocols for such communication include TCP/IP, HTTP, or UDP protocols. Similarly, the application may interface and integrate with delivery systems over a network, based on input data from registered business users 915, such as GRUBHUB™ or MR. DELIVERY™, through a non-graphical interface, to connect and send orders received on the software application to the delivery server if received and if the business official has set up their account in this way. Integrating the delivery system with the application for registered business, to allow business to utilize delivery service for their business, from the application, may take a similar form to integrating for deliveries for customers, except that the customer may be the business itself, for the purpose of ordering supplies and goods from suppliers, on a regular schedule or manually, through the application, providing a single point for this service rather than requiring the business manager or owner to go to the supplier's website for the delivery to be set up. After settings are input for the specific services to integrate and automations to put in place, the application may interface with payment systems, if possible, based on input data from registered users 920, such as connecting to the user's PAYPAL™ or bank account for the purpose of auto-withdrawing funds for bill and payroll payments, or for the purpose of depositing funds into the account(s) when deliveries are ordered and approved. The registered business official or officials may then input business data and set up integration with existing inventory system (if any), and POS (if any) 925 into the application. This is done with a graphical user interface (“GUI”), and may include such data as personal information, business information including business name and location and tax number, menu of food items or other items for non-restaurant businesses, scheduling bill payments and specifying the amount to pay and whom to pay it to, and more. The application may then interface with business-registered point-of-sale systems, if any 925, such as an online website the business operates, which may have a database connection string provided, where the sales software operated may create or edit entries in the database which are then detected by the application, to detect new sales and manage the stored inventory appropriately. The integration may also take the form of online order data such as items bought, purchase confirmation, amount paid, delivery location, and other relevant details as required, being forwarded to the application by the website or other online ordering platform the business may have, and being forwarded to the integrated delivery service such as UBER EATS™. After settings are input for the specific services to integrate and automations to put in place, the application may interface with payment systems, if possible, based on input data from registered users 930, such as connecting to the user's PAYPAL™ or bank account for the purpose of auto-withdrawing funds for bill and payroll payments, or for the purpose of depositing funds into the account(s) when deliveries are ordered and approved.

A customer then may place an order for delivery 935 from a mobile or computing device 111, which may be a mobile phone, tablet, laptop, desktop, personal digital assistant, or other computing device. The order may be placed with a specialized application that the business uses for online POS 160 or a website that is accessible with a web browser, using HTTP, HTTPS, TCP/IP, UDP, or other protocols common for internet communications, and using a possible variety of encryption protocols that are common for such internet communications. This order and the data accompanying it, which may include prescription data or images to verify them, is forwarded from the POS 160 via a network connection, to the application 131, 940, using HTTP, HTTPS, TCP/IP, UDP, or other protocols common for internet communications, and using a possible variety of encryption protocols that are common for such internet communications. An inventory deduction message is sent to the POS 945, 160 if set up by the business in the software application 131, which may be, for instance, a JSON string containing the ID of the inventory item that is being deducted, the amount, and more, for the purposes of local recordkeeping. Delivery information is sent to the delivery service server 170, 950 from the application 131 similarly over a network using HTTP, HTTPS, TCP/IP, UDP, or other protocols common for internet communications, and using a possible variety of encryption protocols that are common for such internet communications, potentially in the form of a JSON, or in another form such as a custom API call to the delivery service, depending on the implementation of the delivery service server. With payroll data input into the application, if the payroll data was input by the business owner or manager during registration and setup 905, 910, this may also be used to automate or allow for manual payment of delivery system fees, financial institution and payment system fees and bills, and inventory management 955 with inventory numbers and POS integration set up, with any orders, changes in inventory or settings, payroll and bill payments, prescription data, or any other changes in any stored accounts or integrated services being stored in a datastore 960 for later viewing and recordkeeping purposes, which may be viewed from the graphical user interface 965. Communications between servers and services in this diagram may take the form of specialized messages between the services, API calls, JSON strings sent to the servers of certain services, or other methods of communication between a web server and another device, many of which are known to the art.

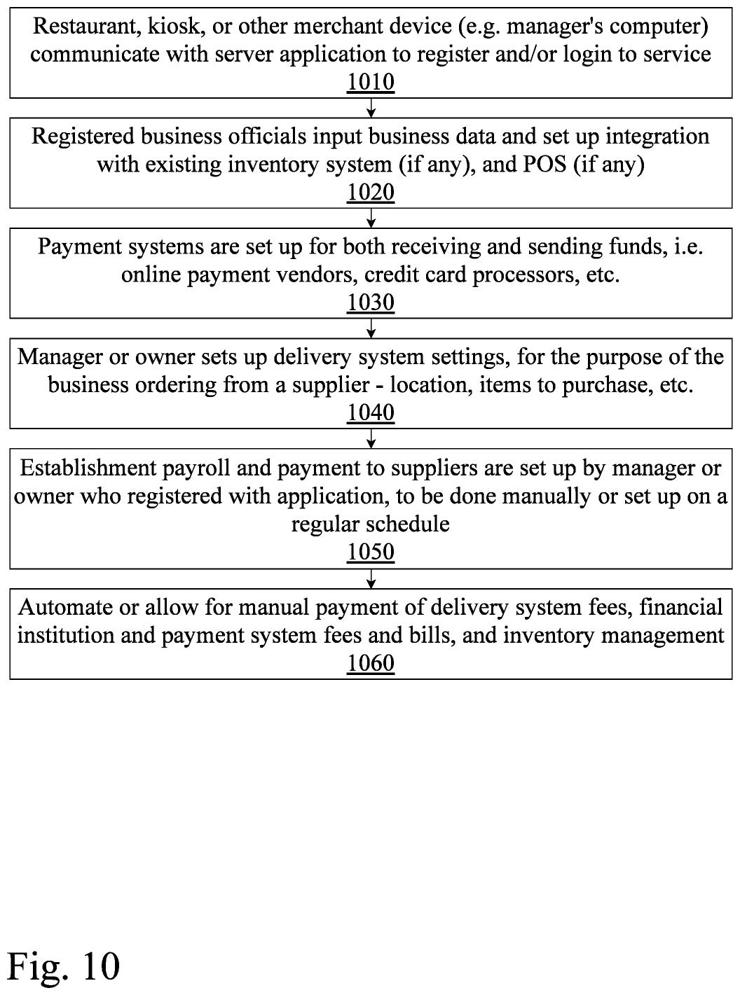

FIG. 10 is a method diagram of an exemplary system for small business service aggregation and abstraction of economies of scale, used for businesses inside of airports for the purposes of managing deliveries of goods to the store or restaurant, integration with existing POS systems, payroll management, and storing any relevant records, according to an embodiment. First, a business device or devices communicate with a server application to register and/or login to service 1010, which may occur using a website and web portal, a specialized application that communicates with the server application, or some other method of communicating with a server and application over a network such as the internet. Protocols for such communication include TCP/IP, HTTP, or UDP protocols. The registered business official or officials may then input business data and set up integration with existing inventory system (if any), and POS (if any) 1020 into the application. This is done with a graphical user interface (“GUI”), and may include such data as personal information, business information including business name and location and tax number, menu of food items or other items for non-restaurant businesses, scheduling bill payments and specifying the amount to pay and whom to pay it to, and more. After settings are input for the specific services to integrate and automations to put in place, payment systems may be set up for both receiving and sending funds, i.e. online payment vendors, credit card processors, etc. 1030, such as connecting to a business' PAYPAL™ or bank account or other financial institution or service for the purpose of auto-withdrawing funds for bill and payroll payments, or for the purpose of depositing funds into the account(s) when deliveries are ordered and approved. In this use case, such funds may be used automatically for the contracts for shipping supplies to the business in the airport, which may even utilize blockchain or smart ledgers to ensure compliance with the contract and payment upon completion, or which may be set up manually but managed by the business manager from within the application. Similarly, the manager or owner may set up delivery system settings, for the purpose of the business ordering from a supplier—location, items to purchase, etc. 1040, rather than deliveries from the business to a customer, the deliveries may be set up from the perspective of delivering to the business itself, from a supplier, through a non-graphical interface, to connect and send orders received on the software application to the delivery server if received and if the business official has set up their account in this way. Integrating business-input payroll information with selected payment systems to automate payroll data 1050 may also be done if the business owner or manager who is registered with the application inputs the payroll data and the proper credentials to pay the employees from their preferred financial institution, using for example STRIPE™ or PAYPAL™ payment services. With the payroll data input into the application, this may also be used to automate or allow for manual payment of delivery system fees, financial institution and payment system fees and bills, and inventory management 1060 with inventory numbers and POS integration set up.

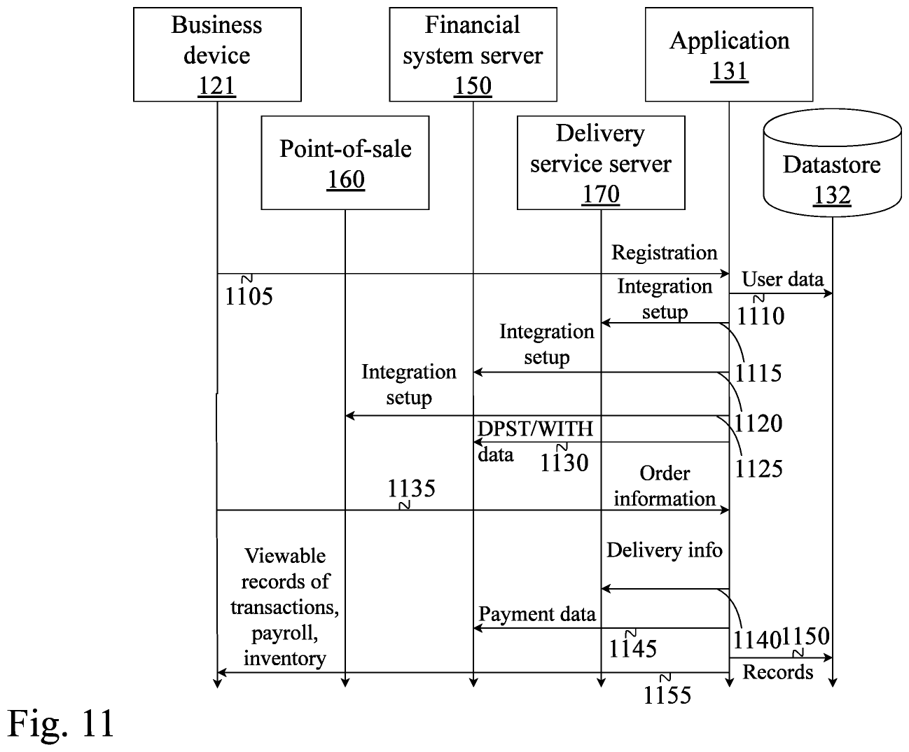

FIG. 11 is a message flow diagram of an exemplary system for small business service aggregation and abstraction of economies of scale, used for businesses inside of airports for the purposes of managing deliveries of goods to the store or restaurant, integration with existing POS systems, payroll management, and storing any relevant records, according to an embodiment. The message flow diagram shows connectivity and exchanged messages, and is described herein with their effects in the system, between at least a business device or devices 121 which may be a personal computer, a mobile phone, a tablet, or other manner of computing device, a point-of-sale or POS system 160 which may include a website or web-accessed application for customers to place delivery orders, a financial system server 150 such as a server accepting communications for services such as PAYPAL™ or VENMO™, a delivery service server 170 such as a server for accepting delivery orders operated by GRUBHUB™ or MR. DELIVERY™, the software application 131, and a datastore 132. First, a business device or devices communicate with a server application to register and/or login to service 1105, which may occur using a website and web portal, a specialized application that communicates with the server application, or some other method of communicating with a server and application over a network such as the internet. Registration data such as the identity and verification methods and values for a newly registered user are stored in a datastore 1110, 132. Protocols for such communication include TCP/IP, HTTP, or UDP protocols. Similarly, the application may interface and integrate with delivery systems over a network, based on input data from registered business users 1115, such as GRUBHUB™ or MR. DELIVERY™, through a non-graphical interface, to connect and send orders received on the software application to the delivery server if received and if the business official has set up their account in this way. Integrating the delivery system with the application for registered business, to allow business to utilize delivery service for their business, from the application, may take a similar form to integrating for deliveries for customers, except that the customer may be the business itself, for the purpose of ordering supplies and goods from suppliers, on a regular schedule or manually, through the application, providing a single point for this service rather than requiring the business manager or owner to go to the supplier's website for the delivery to be set up. After settings are input for the specific services to integrate and automations to put in place, the application may interface with payment systems, if possible, based on input data from registered users 1120, such as connecting to the user's PAYPAL™ or bank account for the purpose of auto-withdrawing funds for bill and payroll payments, or for the purpose of depositing funds into the account(s) when deliveries are ordered and approved. The registered business official or officials may then input business data and set up integration with existing inventory system (if any), and POS (if any) 1125 into the application. This is done with a graphical user interface (“GUI”), and may include such data as personal information, business information including business name and location and tax number, menu of food items or other items for non-restaurant businesses, scheduling bill payments and specifying the amount to pay and whom to pay it to, and more. The application may then interface with business-registered point-of-sale systems, if any 1125, such as an online website the business operates, which may have a database connection string provided, where the sales software operated may create or edit entries in the database which are then detected by the application, to detect new sales and manage the stored inventory appropriately. The integration may also take the form of online order data such as items bought, purchase confirmation, amount paid, delivery location, and other relevant details as required, being forwarded to the application by the website or other online ordering platform the business may have, and being forwarded to the integrated delivery service such as UBER EATS™. Integrating business-input payroll information with selected payment systems to automate payroll data 1130 may also be done if the business owner or manager who is registered with the application inputs the payroll data and the proper credentials to pay the employees from their preferred financial institution, using for example STRIPE™ or PAYPAL™ payment services.

This order is forwarded from the business device 160 via a network connection, to the application 131, 1135, using HTTP, HTTPS, TCP/IP, UDP, or other protocols common for internet communications, and using a possible variety of encryption protocols that are common for such internet communications.

Delivery information is sent to the delivery service server 170, 1140 from the application 131 similarly over a network using HTTP, HTTPS, TCP/IP, UDP, or other protocols common for internet communications, and using a possible variety of encryption protocols that are common for such internet communications, potentially in the form of a JSON, or in another form such as a custom API call to the delivery service, depending on the implementation of the delivery service server. With payroll data input into the application, if the payroll data was input by the business owner or manager during registration and setup 1105, 1110, this may also be used to automate or allow for manual payment of delivery system fees, financial institution and payment system fees and bills, and inventory management 1145 with inventory numbers and POS integration set up, with any orders, changes in inventory or settings, payroll and bill payments, or any other changes in any stored accounts or integrated services being stored in a datastore 1150 for later viewing and recordkeeping purposes, which may be viewed from the graphical user interface 1155. Communications between servers and services in this diagram may take the form of specialized messages between the services, API calls, JSON strings sent to the servers of certain services, or other methods of communication between a web server and another device, many of which are known to the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (“ASIC”), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

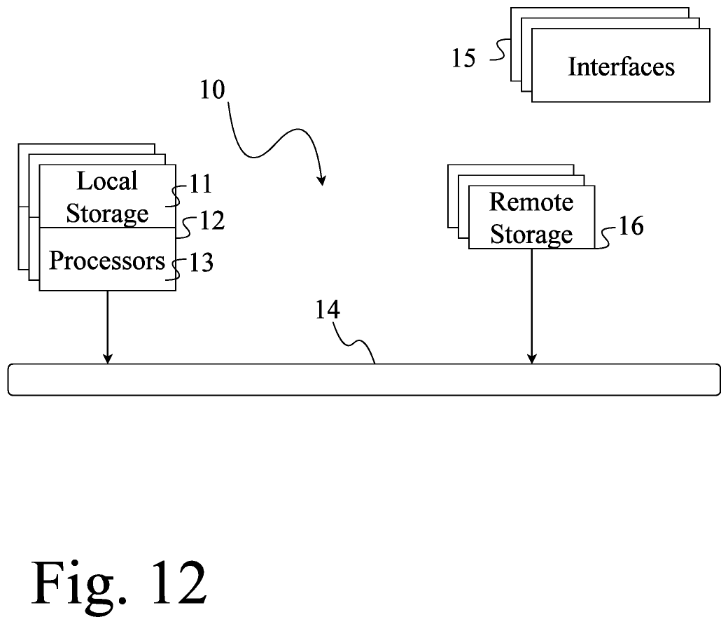

Referring now to FIG. 12, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 12 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

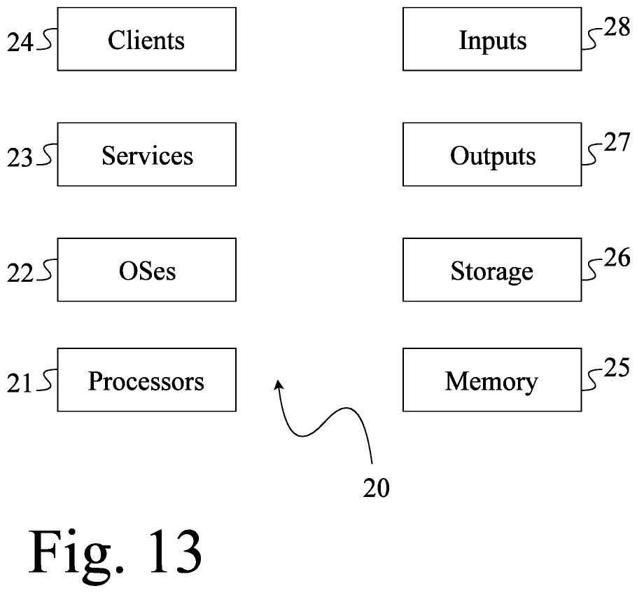

In some embodiments, systems according to the present invention may be implemented on a standalone computing system. Referring now to FIG. 13, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 12). Examples of storage devices 26 include flash memory, magnetic hard drive, CD-ROM, and/or the like.

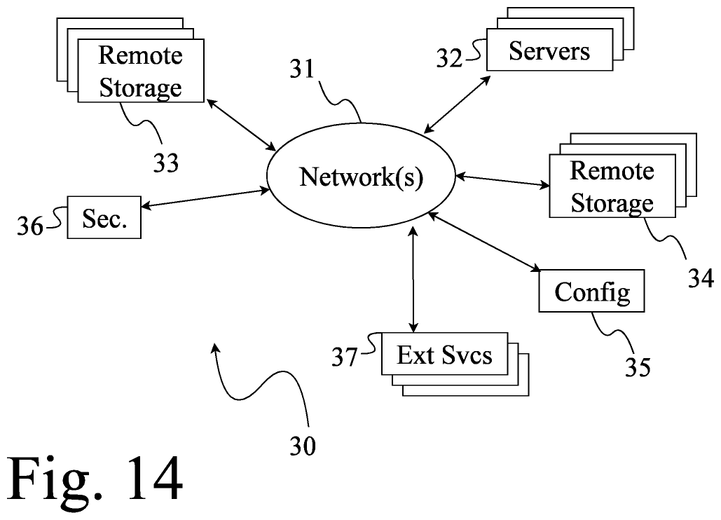

In some embodiments, systems of the present invention may be implemented on a distributed computing network, such as one having any number of clients and/or servers. Referring now to FIG. 14, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 13. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

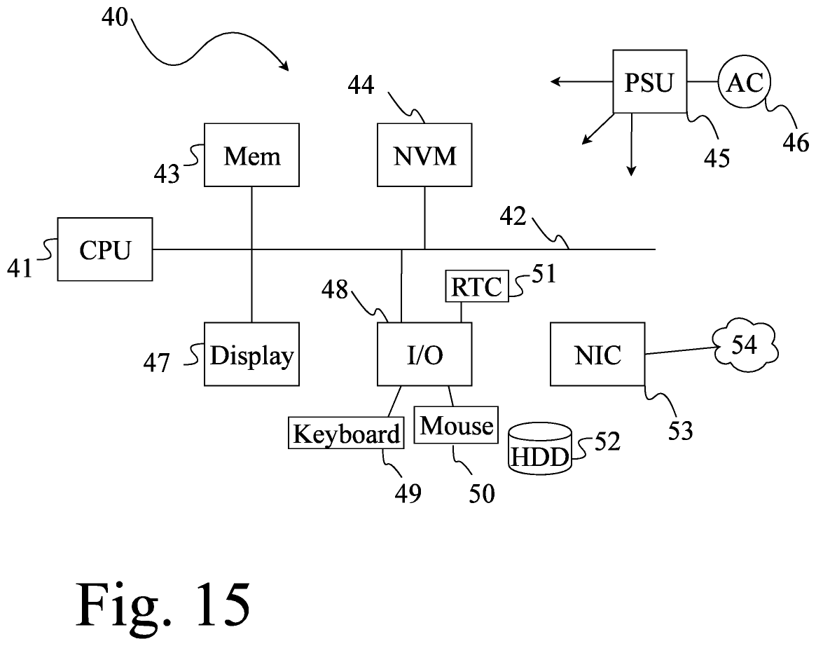

FIG. 15 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for small business service aggregation and abstraction of economies of scale, comprising:
an integration engine comprising a plurality of programming instructions stored in a memory of, and operating on a processor of, a computing device, wherein the programming instructions, when operating on the processor, cause the processor to:
communicate with a plurality of business resources over a network, the plurality of business resources comprising at least one of an inventory management system, a scheduling system, a payment system, a point-of-sale system;
operate an integration application comprising a user interface;
register a user account based on input received via the user interface;
associate at least a portion of the plurality of business resources with the user account;
receive business resource information via the user interface, the business resource information comprising input information corresponding to each business resource associated with the user account; and
a scheduling server comprising a plurality of programming instructions stored in a memory of, and operating on a processor of, a computing device, wherein the programming instructions, when operating on the processor, cause the processor to:
retrieve stored scheduling information from a database, the stored scheduling information being associated with the user account;
direct an inventory management system, if one is associated with the user account, to restock inventory according to at least a portion of the stored scheduling information and at least a portion of the received business resource information, the portion of the received business resource information corresponding to the associated inventory management system;
direct a payment system, if one is associated with the user account, to disburse payroll according to at least a portion of the stored scheduling information and at least a portion of the received business resource information, the portion of the received business resource information corresponding to the associated payment system;
direct a delivery system, if one is associated with the user account, to process deliveries according to at least a portion of the stored scheduling information and at least a portion of the received business resource information, the portion of the received business resource information corresponding to the associated delivery system; and
direct a payment system, if one is associated with the user account, to process bill payments according to at least a portion of the stored scheduling information and at least a portion of the received business resource information, the portion of the received business resource information corresponding to the associated payment system.

2. A method for small business service aggregation and abstraction of economies of scale, comprising the steps of:
registering, via a user interface provided by an integration application operating on an integration engine, a user account;
associating a plurality of business resources with the user account, the plurality of business resources comprising at least one of an inventory management system, a scheduling system, a payment system, a point-of-sale system;
receiving business resource information via the user interface, the business resource information comprising input information corresponding to each business resource associated with the user account;
retrieving, using a scheduling server, stored scheduling information from a database, the stored scheduling information being associated with the user account;
directing an inventory management system, if one is associated with the user account, to restock inventory according to at least a portion of the stored scheduling information and at least a portion of the received business resource information, the portion of the received business resource information corresponding to the associated inventory management system;
directing a payment system, if one is associated with the user account, to disburse payroll according to at least a portion of the stored scheduling information and at least a portion of the received business resource information, the portion of the received business resource information corresponding to the associated payment system;
directing a delivery system, if one is associated with the user account, to process deliveries according to at least a portion of the stored scheduling information and at least a portion of the received business resource information, the portion of the received business resource information corresponding to the associated delivery system; and
directing a payment system, if one is associated with the user account, to process bill payments according to at least a portion of the stored scheduling information and at least a portion of the received business resource information, the portion of the received business resource information corresponding to the associated payment system.
